(19) United States
(12) Patent Application Publication
(10) Pub. No.: US 2005/0190337 A1
(43) Pub. Date: Sep. 1, 2005

(54) Liquid crystal display device and method for manufacturing the same

(76) Inventors: Tae Kyu Park, Kyoungki-do (KR); Sung Hun Song, Kyoungki-do (KR); Sung Woon Kim, Kyoungki-do (KR)

Correspondence Address: Richard J. Streit;Ladas & Parry LLP, Suite 1200, 224 South Michigan Avenue, Chicago, IL, 60604, US

(21) Appl. No.: 11/054,187

(22) Filed: Feb. 9, 2005

Related U.S. Application Data
(63) Continuation-in-part of application No. 10/317,794, filed on Dec. 12, 2002, now abandoned.

(30) Foreign Application Priority Data
Jan. 29, 2002 (KR) 2002-5077

(51) Int. Cl. G02F 1/1339

(52) U.S. Cl. 349/155

(57) ABSTRACT

A liquid crystal display device having robust post spacers has a transparent insulation substrate on which a black matrix is formed. Red, green and blue color filters in each of the sub pixels defined by the black matrix are then formed. An overcoating layer is formed on the color filters and the black matrix. A post spacer is formed surrounding the four sides of each of the sub-pixels wherein red, green and blue color filters formed and having a groove on the middle portion of each of the sides surrounded. A liquid crystal layer is formed by polymer dispersed liquid crystal. A liquid crystal layer consisting of a polymer dispersed liquid crystal is formed on the overcoating layer including the post spacer.

### BACKGROUND OF THE INVENTION

1. Field of the Invention

The present invention relates generally to a liquid display device and a method of manufacturing the same, and more particularly to improving screen grade by providing the improved post spacer structure in the liquid display device.

2. Description of the Prior Art

In the conventional liquid display device employing a post spacer, a color filter substrate is fabricated by forming, in turn, a black matrix on the glass substrate, forming red, green and blue color filters, forming an overcoating layer, forming an indium tin oxide (ITO) layer, and forming a post spacer.

In here, the ITO layer is formed in the mode using a vertical electric field, such as a twisted nematic (TN) mode, not in the mode using a parallel electric field, such as a fringe-field switching (FFS) or in-plane switching (IPS).

FIG. 1 is a plan view for describing a conventional color filter substrate of a liquid crystal display and shows a black matrix 3, a sub pixel 5, in which one of red, green, or blue color filters are formed, and a post spacer 7.

However, according to this liquid crystal display device of the prior art as shown in FIG. 1, the interval between any two of the patterned post spacers 7 is too wide, and the dimension of each post spacer 7 is too small. Therefore, when certain one or a few of the post spacers has a breakage or defect, it causes the cell gap of the affected area to be different from that of the other parts with functioning post spacers 7 without breakage. This cell gap difference between any two or more parts of the liquid crystal display due to defective post spacers 7 may likely cause the whole liquid crystal display to be defective as a dapple would be observed through a panel.

To solve the above-mentioned problem, a prior invention as shown in FIGS. 2A-2C proposes that the post spacers 17 be formed on a layer above the layer having the black matrix 13 covering the entire area of a black matrix 13 formed on a substrate 10 as this is shown in FIG. 2A. In FIGS. 2B and 2C, each figure shows variation in the arrangement of the post spacers 17 under consideration of a rubbing direction and of a direction of a liquid crystal injection opening. In FIG. 2B, vertically parallel post spacers 17 are formed on a layer above the layer having the black matrix 13, whereas in FIG. 2C, horizontally parallel post spacers 17 are formed on a layer above the layer having the black-matrix 13. As shown in FIGS. 2A-2C, the sub-pixels 5 are not blocked or covered by the post spacers 17 or the black matrix 13.

However, even the prior invention mentioned immediately above also has many problems. Even though the post spacers of the prior invention are designed to be disposed in one direction depending on the processing direction in a polyimide (PI) coating or rubbing process (as shown in FIGS. 2B-2C), the area of the post spacers is still too large. Therefore, there is a possibility of generating scratches or coating defects by a height difference between the post spacers during processing. Further, since the passways unblocked by the post spacers 17 through which the liquid crystal flows, are blocked on at least one side by the post spacers (for example, blocked in horizontal directions in FIG. 2B and blocked in vertical directions in FIG. 2C), it is difficult for the liquid crystal to flow during injection of liquid crystal.

### SUMMARY OF THE INVENTION

Accordingly, the present invention has been made to solve the above-mentioned problems occurring in the prior art, and an object of the present invention is to provide a liquid crystal display device and a method for manufacturing the same which employ post spacers enabling liquid crystal to flow smoothly.

Another object of the present invention is to provide a liquid crystal display device and method for manufacturing the same capable of preventing defects in polyimide (PI) coating and scratches.

In order to accomplish these objects, a method for manufacturing a liquid crystal display device according to the present invention comprises the steps of: preparing a transparent insulation substrate; forming a black matrix on the substrate; forming red, green and blue color filters in each of the sub pixels defined by the black matrix; forming an overcoating layer on the color filters and the black matrix; forming a post spacer surrounding the four sides of each of the sub-pixels wherein red, green and blue color filters formed and having a groove on the middle portion of each of the sides surrounded; and forming a liquid crystal layer consisting of a polymer dispersed liquid crystal on the overcoating layer including the post spacer.

Furthermore, a liquid crystal display device according to the present invention comprises: a transparent insulation substrate; a black matrix formed on the substrate; red, green and blue color filters formed in each of the sub pixels defined by the black matrix; an overcoating layer formed on the color filters and the black matrix; a post spacer surrounding the four sides of each of the sub-pixels wherein red, green and blue color filters formed and having a groove on the middle portion of each of the sides surrounded; and a liquid crystal layer consisting of a polymer dispersed liquid crystal on the resulting substrate including a post spacer.

### BRIEF DESCRIPTION OF THE DRAWINGS

The above and other objects, features and advantages of the present invention will be more apparent from the following detailed description taken in conjunction with the accompanying drawings, in which:

FIG. 1 is a plan view showing an example of a conventional color filter substrate in a liquid crystal display device according to prior art;

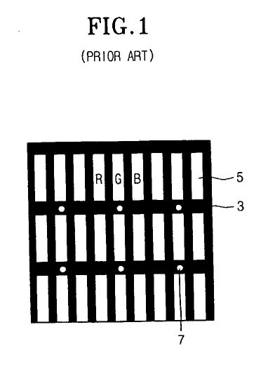

FIGS. 2A, 2B, and 2C are plan views showing other examples of conventional color filter substrates in a liquid crystal display device according to prior art.

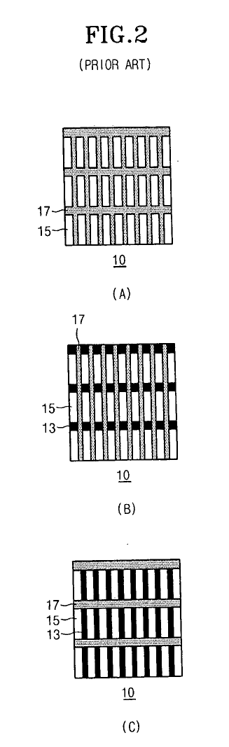

FIG. 3 is a plan view showing a liquid crystal display device according to a first embodiment of the present invention;

FIGS. 4A, 4B, and 4C are cross-sectional views along the lines A-A′, B-B′, and C-C′, respectively, of FIG. 3;

FIG. 5 is a cross-sectional view for describing a driving principle of a polymer dispersed liquid crystal (PDLC) in a liquid crystal display device and a method for manufacturing the same according to a first embodiment of the present invention; and

FIG. 6 is a cross-sectional view for describing a liquid crystal display device and a method for manufacturing the same according to a second embodiment of the present invention.

### DETAILED DESCRIPTION OF THE PREFERRED EMBODIMENTS

Hereinafter, a preferred embodiment of the present invention will be described with reference to the accompanying drawings.

In a method for manufacturing a liquid crystal display device according to a first embodiment of the present invention, a black matrix of resin or chrome (Cr) or other suitable material well known to those skilled in the pertinent art is formed on a transparent insulation substrate such as glass. Then, red, green and blue filters are formed in each of the sub pixels defined by the black matrix. An overcoating layer is formed on the entire substrate including the color filters and the black matrix.

An ITO layer is formed in the mode using a vertical electric field, such as a twisted nematic (TN) mode, not in the mode using a parallel electric field, such as a fringe-field switching (FFS) or in-plane switching (IPS).

Subsequently, a photoresist is formed on the overcoating layer, and then exposed in the presence of a patterned mask, thereby forming a post spacer. The post spacer has a thickness ranging from approximately 2 to 10 μm.

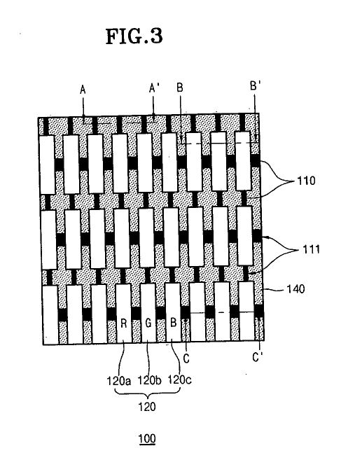

Here, as shown in FIG. 3, each of the red filter 120a, green filter 120b and blue filter 120c is defined as a sub-pixel. Reference numeral 120 is collectively referred to as a color filter.

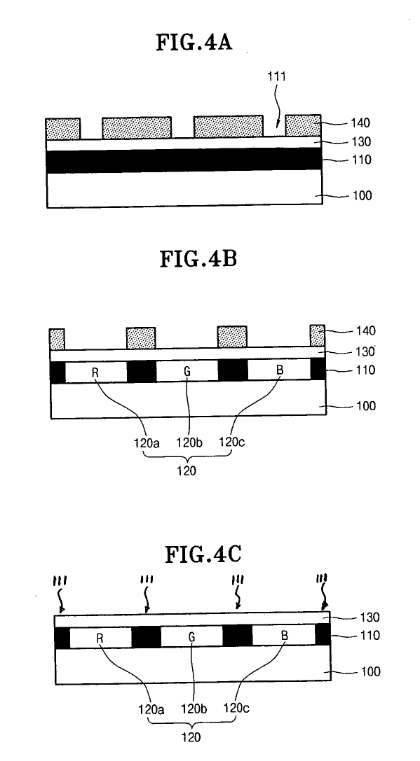

FIGS. 4A-4C which are sectional views according to lines A-A′, B-B′ and C-C′ of FIG. 3. show that the black matrix 110 is formed on the transparent insulation substrate 100, red filter 120a, green filter 120b and blue filter 120c are formed in each of the sub pixels defined by the black matrix, the overcoating layer 130 is formed on the color filters 120a, 120b, 120c and the black matrix 110, and the post spacer 140 having grooves 110 is formed on the overcoating layer 130.

Each of the sub-pixels of color filters 120a, 120b, 120c are defined or bound by black matrix 110 on the same layer as this is shown in FIGS. 4A-4B. An overcoating layer 130 (not shown in FIG. 3) is formed above the layer of the supixels 120a, 120b, 120c defined by the black matrix 110 as shown in FIGS. 4A-4C. The post spacers 140 are formed on the overcoating layer 130 (as shown in FIGS. 4A-4C) generally surrounding the four sides of each of the sub-pixels 120a, 120b, 120c without overlapping the sub-pixels 120a, 120b, 120 formed below the layer of the overcoating later 130 (as shown in FIGS. 3 and 4A-4C).

Therefore, as shown in FIGS. 3 and 4A-4C, each sub-pixel space formed above each sub-pixel 120a, 120b, 120c is defined by four adjacent post spacers 140. In FIG. 3, the sub-pixel space is shown in a rectangular shape, but it should be readily apparent that other shapes are possible, which are dependent largely on the shapes of the sub-pixel 120a, 120b, 120c formed on the layer below.

The sub-pixel space as shown in FIG. 3 of the rectangular shape (overlapping the sub-pixels 120a, 120b, 120c on a different layer as shown in FIGS. 4A-4C) is not isolated from the four adjacent sub-pixel spaces. Each rectangular sub-pixel space of FIG. 3 is connected to the four nearby sub-pixel spaces by grooves 111. FIG. 3 shows that one sub-pixel space is connected to the four nearby sub-pixel spaces, but it should be readily apparent to those skilled in the art that different connection arrangement in terms of the number of connected sub-pixel spaces by grooves 111 or the location of the grooves with respect to the sub-pixel spaces or others.

As shown in FIGS. 4A-4C, grooves 111 are formed to overlap the black matrix 110 above the overcoating layer 130 such a way that the two sub-pixel spaces are connected by each groove 111. This is the reason why FIG. 3 shows that the lines or arrows for the black matrix 110 and the groove 111 point to the same location, but it should be clear from FIGS. 4A-4C that the black matrix 110 and the grooves 111 are formed on different layers. The groove 111 may be formed at a size of 1 μm or up to the same size as the width (or the length) of the sub-pixel, but it should be readily apparent to those skilled in the art that a different size can be utilized.

The top layer of each of FIGS. 4A-4C (of the post spacers 140, the sub-pixel spaces formed above the sub-pixels 120a, 120b, 120c, and grooves 111) are also referred to as a color filter layer. Then, though not shown in the drawings, the liquid crystal layer is formed above the color filter substrate. The liquid crystal layer is held in the layer above the color filter layer as the substrate of layers 100, 110, 130, 140 shown in FIGS. 4A-4C is bonded with an array substrate (not shown) having an ITO layer and a switching device such as a thin film transistor (TFT), such that the liquid crystal display device of the present invention is fabricated. At this time, the entire substrate is preferably subjected to planarization so that it has a high compatibility with the color filter substrate in which the post spacer has a large area.

Further, it is preferred that polymer dispersed liquid crystal (PDLC), in which polymer and liquid crystal are mixed and dispersed, is used for the liquid crystal layer (not shown). In this case, a polyimide (PI) coating failure or a scratch can be prevented, which may be generated during a subsequent PI coating or rubbing process, resulting from height differences. Specifically, since the PDLC is mixed with polymer and liquid crystal at a constant rate, the liquid crystal is capable of being aligned or driven without PI coating and aligning processes.

Also, it is preferred that the liquid crystal layer (not shown) is formed in a one-drop filling process, because this process can facilitate a smooth flow of the liquid crystal to form a uniform cell gap.

In addition, since the post spacers 140 are separated by a groove 111 and the sub-pixel spaces and surrounding each of the sub pixel spaces, it is easy for the liquid crystal to smoothly flow over the entire or largely defined area of the liquid crystal layer through the sub-pixel spaces and grooves 111, and this provides one of many significant advantages of the present invention over prior art.

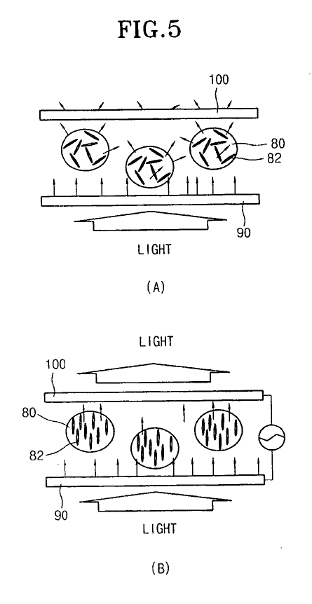

As shown in FIGS. 5A-5B, when the liquid crystal display device of the present invention constructed as above is not powered (see FIG. 5A), the device cannot present images by scattering light. In contrast, when the device is powered (see FIG. 5B), the device can present certain images by regularly arranging the liquid crystal 82 within the polymer 80 in a certain direction along the electric field, and by transmitting light upwardly.

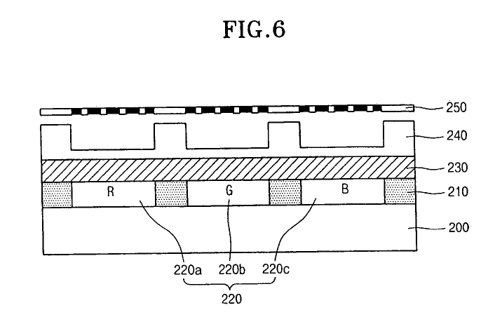

In the method of manufacturing a liquid crystal display device according to a second embodiment of the present invention, as shown in FIG. 6, a black matrix 210 of resin or chrome (Cr) is formed on a transparent insulation substrate 200 such as glass. Then, a color filter 220 made up of a red filter 220a, a green filter 220b and a blue filter 220c, is formed in each of the sub-pixels defined by the black matrix 210. That is, each of the filters 220a, 220b, 220c is defined in a sub-pixel in the similar manner as shown in FIG. 3.

Next, an overcoating layer 230 is formed on the layer of the black matrix 210 and the color filters 220. And then, an ITO layer (not shown) is formed in the mode using a vertical electric field, such as a twisted nematic (TN) mode, not in the mode using a parallel electric field, such as a fringe-field switching (FFS) or in-plane switching (IPS).

Subsequently, a photosensitive polymer acting as an alignment layer is applied on the overcoating layer 230, and then exposed to light in the presence of a half tone mask to form post spacers 240. The post spacers 240, through the properties of their materials, have a double function as an alignment layer as well as an overcoating layer.

Herein, the detailed description on the other processes will be omitted, because they are the same as those of the first embodiment of the present invention. The structures of the sub-pixel spaces and grooves are not shown in FIG. 6, but it should be recognized that the same structures of the sub-pixel spaces and grooves shown and described with respect to FIGS. 3 and 4A-4C can be applied to the structure of shown in FIG. 6.

As seen from the above, a liquid crystal display device and method for manufacturing the same according to the embodiments of the present invention can obtain effects as following.

According to the present invention, it is possible to enable liquid crystal to flow smoothly due to the grooves formed in the post spacer whose area is big, enough to prevent defects in the polyimide (PI) coating and scratches by using a polymer dispersed liquid crystal (PDLC), and to decrease the time for injecting liquid crystal by using a one-drop filling (ODF) process. Therefore, present invention provides an improved screen grade, the decreased number of processing steps, as well as the cost-effective processing steps in manufacturing the liquid crystal display.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A method of manufacturing a liquid crystal display device, comprising the steps of:
preparing a transparent insulation substrate;
forming color filters on the substrate, wherein the color filters are separated by a black matrix, and wherein a sub-pixel is an area of the color filter defined by the black matrix;
forming an overcoating layer on the color filters and the black matrix, wherein a sub-pixel space is an area on the overcoating layer corresponding to the area of the sub-pixel below the overcoating layer;
forming post spacers on the overcoating layer, wherein each sub-pixel space is surrounded by a plurality of post spacers and wherein each sub-pixel space is connected to at least one nearby sub-pixel space by a groove formed between two post spacers; and
forming a liquid crystal layer of polymer dispersed liquid crystal on the overcoating layer and in the sub-pixel spaces surrounded by a plurality of post spacers.

2. The method of claim 1, wherein the size of each groove is 1 μm to the size of the width or length of the sub-pixel.

3. The method of claim 1, wherein the post spacer is formed at a height of 2 to 10 μm.

4. The method of claim 1, wherein the liquid crystal layer is formed in a one-drop filling process.

5. A liquid crystal display device, comprising:
a transparent insulation substrate;
color filters formed on the substrate, wherein the color filters are separated by a black matrix, and wherein a sub-pixel is an area of the color filter defined by the black matrix;
an overcoating layer formed on the color filters and the black matrix, wherein a sub-pixel space is an area on the overcoating layer corresponding to the area of the sub-pixel below the overcoating layer;
post spacers formed on the overcoating layer, wherein each sub-pixel space is surrounded by a plurality of post spacers and wherein each sub-pixel space is connected to at least one nearby sub-pixel space by a groove formed between two post spacers; and
a liquid crystal layer of polymer dispersed liquid crystal formed on the overcoating layer and in the sub-pixel spaces surrounded by a plurality of post spacers.

6. The liquid crystal display device of claim 5, wherein the size of each groove is 1 μm to the size of the width or length of the sub-pixel.

7. The liquid crystal display device of claim 5, wherein the post spacer is formed at a height of 2 to 10 μm.

8. The liquid crystal display device of claim 5, wherein the black matrix is made from a material including a resin or a chrome.

9. The liquid crystal display device of claim 5, wherein the substrate is made from a material including glass.

10. A method of manufacturing a liquid crystal display device, comprising the steps of:
preparing a transparent insulation substrate;
forming color filters on the substrate, wherein the color filters are separated by a black matrix, and wherein a sub-pixel is an area of the color filter defined by the black matrix;
forming an overcoating layer on the color filters and the black matrix, wherein a sub-pixel space is an area on the overcoating layer corresponding to the area of the sub-pixel below the overcoating layer;
forming a layer of photosensitive polymer acting as an alignment layer on the overcoating layer;
forming a half tone mask on the photosensitive polymer layer;
exposing to light the preselected areas surrounding the sub-pixel space of the photosensitive polymer layer according to the pattern of the half tone mask to form post spacers,
wherein each sub-pixel space is surrounded by a plurality of post spacers,
wherein each sub-pixel space is connected to at least one nearby sub-pixel space by a groove formed between two post spacers, and
wherein the post spacers is also the alignment layer; and
forming a liquid crystal layer of polymer dispersed liquid crystal on the alignment layer of post spacers and in the sub-pixel spaces surrounded by a plurality of post spacers.

11. The method of claim 10, wherein the size of each groove is 1 μm to the size of the width or length of the sub-pixel.

12. The method of claim 10, wherein the post spacer is formed at a height of 2 to 10 μm.

13. The method of claim 10, wherein the liquid crystal layer is formed in a one-drop filling process.

14. The method of claim 10, further comprising the step of forming a transparent conductive layer on the black matrixes and the color filter layers.

15. The method of claim 14, wherein the transparent conductive layer is made from a material including indium-tin oxide (ITO).

16. A liquid crystal display device, comprising:
a transparent insulation substrate;
color filters formed on the substrate, wherein the color filters are separated by a black matrix, and wherein a sub-pixel is an area of the color filter defined by the black matrix;
an overcoating layer formed on the color filters and the black matrix, wherein a sub-pixel space is an area on the overcoating layer corresponding to the area of the sub-pixel below the overcoating layer;
a layer of photosensitive polymer acting as an alignment layer formed on the overcoating layer;
a half tone mask formed on the photosensitive polymer layer,
wherein the half tone mask is capable of exposing to light the preselected areas surrounding the sub-pixel space of the photosensitive polymer layer according to the pattern of the half tone mask to form post spacers.

17. A liquid crystal display device, comprising:
a transparent insulation substrate;
color filters formed on the substrate, wherein the color filters are separated by a black matrix, and wherein a sub-pixel is an area of the color filter defined by the black matrix;
an overcoating layer formed on the color filters and the black matrix, wherein a sub-pixel space is an area on the overcoating layer corresponding to the area of the sub-pixel below the overcoating layer;
a layer of photosensitive polymer acting as an alignment layer formed on the overcoating layer,
wherein a plurality of post spacers are formed by portions of the photosensitive polymer corresponding to the sub-pixel spaces by a half-tone mask,
wherein each sub-pixel space is surrounded by a plurality of post spacers,
wherein each sub-pixel space is connected to at least one nearby sub-pixel space by a groove formed between two post spacers, and
wherein the post spacers is also the alignment layer; and
forming a liquid crystal layer of polymer dispersed liquid crystal on the alignment layer of post spacers and in the sub-pixel spaces surrounded by a plurality of post spacers.

18. The liquid crystal display device of claim 17, wherein the size of each groove is 1 μm to the size of the width or length of the sub-pixel.

19. The liquid crystal display device of claim 18, wherein the post spacer is formed at a height of 2 to 10 μm.
